(19) United States
(12) Patent Application Publication
(10) Pub. No.: US 2011/0254829 A1
(43) Pub. Date: Oct. 20, 2011

(54) Wearable electronic device, viewing system and display device as well as method for operating a wearable electronic device and method for operating a viewing system

(75) Inventors: Markus AGEVIK, Malmo (SE); Martin EK, Dalby (SE); Martin NYSTROM, Horja (SE); Eric STROMGREN, Lund (SE); Magnus ABRAHAMSSON, Loddekopinge (SE)

(73) Assignee: SONY ERICSSON MOBILE COMMUNICATIONS AB, Lund (SE)

(21) Appl. No.: 12/761,624

(22) Filed: Apr. 16, 2010

(51) Int. Cl. G06F 3/038

(52) U.S. Cl. 345/213

(57) ABSTRACT

The present invention relates to a wearable electronic device, a viewing system comprising the wearable electronic device, a display device and methods for operating a wearable electronic device and a viewing system, respectively, wherein the wearable electronic device comprises a pair of glasses which can be controlled to change their optical state in a way to allow other and more flexible use of the equipment. The wearable electronic device for watching images comprises a left glass and a right glass which are adapted to change between a dark state and a transparent state of the glass and a controller operable to control the state of the glasses synchronous with a display of a plurality of images per second by a display device so that said left glass and said right glass are both in a dark state at the same time for a specific displayed image.

### FIELD OF THE INVENTION

The present invention relates to a wearable electronic device, a viewing system comprising the wearable electronic device, a display device and methods for operating a wearable electronic device and a viewing system, respectively, wherein the wearable electronic device comprises a pair of glasses which can be controlled to change their optical state.

### BACKGROUND

In recent years, TV sets and computer monitors based on cathode ray tube (CRT) displays have been largely replaced by flat screens based on LCD or plasma technology. Screen sizes of more than one meter and frame rates over 50 Hz are not uncommon. In CRT displays, the frame rate was previously associated with the frequency of the AC mains power and thus other frequencies were not easily possible.

Furthermore, to enhance the viewer's experience, flat screens with three-dimensional (3D) display capabilities have been introduced by various techniques. For example, display devices with auto-stereoscopic displays and display systems used in conjunction with shutter glasses have been introduced.

Viewing a movie in 3D on a display using shutter glasses, requires that the left and right eyes of the viewer are shown alternately different images in synchronization with the refresh rate of the display, while the display alternately displays different perspectives for each eye. The equipment for such 3D systems to perceive 3D images is complex and expensive.

It is desirable to provide a novel wearable electronic device, viewing system, display device and methods for operating the wearable electronic device and viewing system, respectively, allowing other and more flexible use of the equipment.

### DISCLOSURE OF INVENTION

A novel wearable electronic device, viewing system, a display device and methods for operating the same are presented in the independent claims. Advantageous embodiments are defined in the dependent claims.

An embodiment of the invention provides a wearable electronic device for watching images comprising a left glass and a right glass, e.g. a pair of glasses, which are adapted to change between a dark state and a transparent state of the glass. The wearable electronic device further comprises a controller operable to control the state of the glasses synchronous with a display of a plurality of images per second by a display device so that the left glass and the right glass are both in a dark state at the same time for a specific displayed image. Accordingly, a user of the wearable electronic device is enabled to block a specific image or image series, such as a TV program, so as to watch a different image series without interference.

In one embodiment, the left glass and the right glass are periodically in a dark state at the same time. Accordingly, the period defining the periodically occurring dark states may be defined by the synchronization.

In one embodiment, the left glass and the right glass are periodically in a transparent state at the same time. Accordingly, a user is enabled to watch with the left and right eye at the same time an image series, such as a TV program.

In one embodiment, the left glass and the right glass are both alternately in a transparent state at one time and in a dark state at another time. Accordingly, one image series can be blocked and another image series can be viewed at different times.

In one embodiment, the wearable electronic device further comprises a receiving section operable to receive a signal indicating to the controller to control the state of the glasses so that the left glass and the right glass are both switched in a dark state at the same time. Accordingly, a signal, for example from an external source, such as the display device, may determine the dark state of the glasses.

For example, the above-described wearable electronic device allows multiple users to view images independently on the same display device, wherein different images for different users are shown at different times, and wherein the wearable electronic device used by one viewer can block the images provided for a different viewer.

According to another embodiment, a viewing system is provided comprising the wearable electronic device, discussed above, as well as a display device operable to sequentially display the plurality of images. Accordingly, a viewing system for one user is provided.

In one embodiment, the plurality of images comprises at least a first and a second image series. Accordingly, at least two different programs, movies, websites or a combination thereof can be provided by the viewing system.

In one embodiment, the controller is adapted to control a state of the glasses so that the left glass and the right glass are both switched in a dark state when images of the second image series are displayed. Accordingly, a specific image series, such as a program or movie, can be selected by the user to be blocked so as to enable the user to view another image series without distortion.

In one embodiment, the second images series constitutes a second program for a second user or inverted images to the first image series. Accordingly, two different users may view different image series, such as TV programs, or one user may view an image series in a privacy mode, wherein other users without suitable wearable electronic devices view a mixture of images with content and images with the corresponding inverted content so that the combination basically results in an overall grey image.

In one embodiment, the first image series comprises images with different perspectives for each eye of a user which are alternately displayed, and the controller is adapted to control the state of the glasses ultimately so that the left glass is transparent for one perspective and the right glass is transparent for the other perspective. Accordingly, images can be viewed by a user which provide a virtual three-dimensional viewing perception, since different perspectives are provided for each eye.

In one embodiment, the viewing system further comprises a second pair of glasses having a left glass and a right glass which are adapted to change between a dark state and a transparent state of the glass. Accordingly, two users having each a pair of glasses can view two different programs on the same display device at the same time.

In one embodiment, the controller is adapted to control a state of the glasses of the second pair of glasses so that the left glass and the right glass are both switched in a dark state at the same time when images of the first image series are displayed. Accordingly, the first image series is blocked for the user of the second pair of glasses so as to avoid interference between the first and second image series when being viewed.

In one embodiment, the display device comprises an auto-stereoscopic display device. Accordingly, a viewer may view three-dimensional information with the left and the right eye at the same time so that alternately showing a perspective for the left eye and then another perspective for the right eye is not necessary.

According to another embodiment, a display device for displaying images is provided. The display device comprises a display section operable to sequentially display a plurality of images, wherein the plurality of images comprises at least a first and a second image series. The display device further comprises a transmitting section operable to transmit a signal indicating the display of images of the first image series and of the second image series so as to switch a state of both glasses of a pair of glasses at the same time in a dark state synchronous with the display of the second image series. Accordingly, a display device displaying two different image series, such as two different programs alternately is provided.

According to another embodiment, a method for operating a wearable electronic device is provided having a left glass and a right glass for watching images, the left glass and the right glass are adapted to change between a dark state and a transparent state of the glass. The method comprises the step of controlling the state of the glasses synchronous with a display of a plurality of images per second so that the left glass and the right glass are both in a dark state at the same time for a specific displayed image.

According to another embodiment, a method for operating a viewing system with a display device and an electronic device having a left glass and a right glass is provided, wherein the left glass and the right glass are adapted to change between a dark state and a transparent state of the glass. The method comprises the steps of sequentially displaying a plurality of images per second comprising at least a first and a second image series, and controlling the state of the glasses synchronous with a display of the plurality of images so that the left glass and the right glass are both in the dark state at the same time for a specific displayed image of the second image series.

### BRIEF DESCRIPTION OF THE DRAWINGS

Embodiments of the invention will be described with respect to the following appended figures.

FIG. 1 illustrates a wearable electronic device and elements thereof according to an embodiment of the invention.

FIG. 2a illustrates the control of wearable electronic devices in a viewing system.

FIG. 2b illustrates the control of wearable electronic devices in a viewing system so that a user obtains a 3D perception.

FIG. 3 illustrates an example how different content can be delivered to different users viewing the same display device.

FIG. 4 illustrates an example how a user may view private content on a display device although other people can view the display device at the same time.

FIG. 5 illustrates a flow diagram of a method for operating a wearable electronic device according to an embodiment of the invention.

FIG. 6 illustrates a viewing system and elements thereof according to another embodiment of the invention.

FIG. 7 illustrates a method for operating a viewing system according to another embodiment of the invention.

### DESCRIPTION OF THE EMBODIMENTS

The further embodiments of the invention are described with reference to the figures. It is noted that the following description contains examples only and should not be construed as limiting the invention.

In the following, similar or same reference signs indicate similar or same elements.

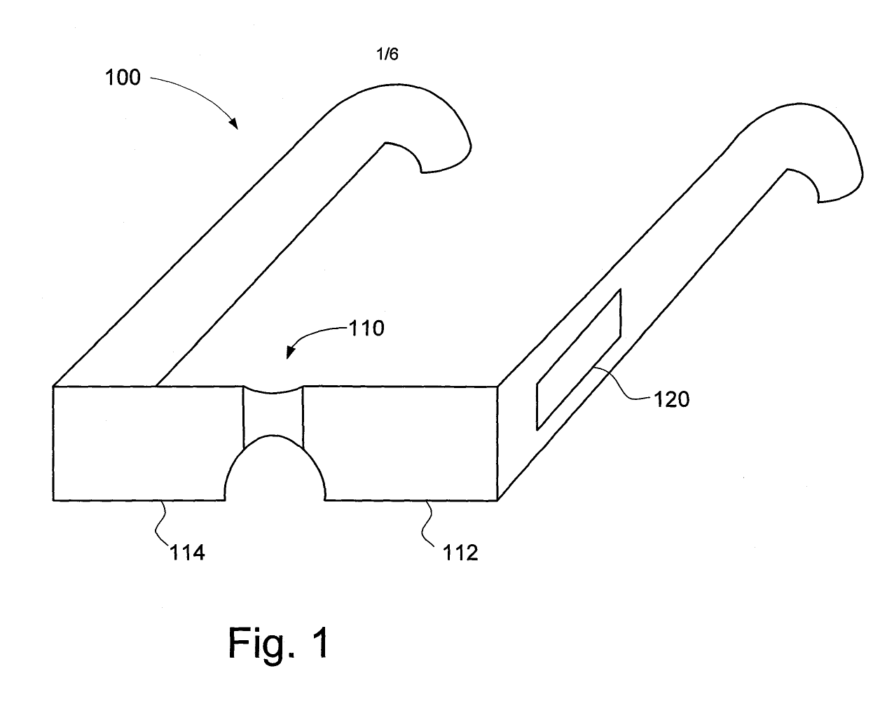

FIG. 1 illustrates a wearable electronic device 100 according to an embodiment of the invention. FIG. 1 illustrates the wearable electronic device 100 comprising a pair of glasses 110 having a left glass 112 and a right glass 114 which are adapted to change between a dark state and a transparent state of the glass, which will be described in more detail below.

A dark state may be understood as a state, in which the glass is largely non-transparent, i.e. opaque, so that light cannot be transmitted or is only transmitted by a small percentage. Such a dark state may be achieved by absorbing, reflecting or scattering light hitting the glass.

It is appreciated that the term glass is not limited to a specific glass, such as silica glass, but should be understood as a material that is transparent in a specific state or more transparent than the dark state. This material may be a solid or a liquid, wherein the liquid may be kept in a suitable compartment. For example, materials with polarizing properties when an electric field is applied can be used. If such material is combined with one or more polarisers switching between a dark state and transparent state can be achieved, for example.

Further, the wearable electronic device 100 comprises a controller 120 operable to control the state of the glasses synchronous with a display of a plurality of images per second by a display device so that the left glass and the right glass are both in a dark state at the same time for a specific displayed image. The controller 120 may comprise a microprocessor, CPU or other electronic circuit as well as a memory to store a program code to be executed by the processor.

The synchronization is preferably performed in accordance with new content shown on the display device, i.e. a new image. For example, the frame rate of the display device, i.e. the rate at which new images are displayed per second, is used for synchronization. In other words, the dark and transparent state of the glasses of the wearable electronic device are shifted synchronized with the content that is shown on the display device. Here, the frame rate does not necessarily have to coincide with the refresh rate of the display device, since the refresh rate may be higher and a second image with the same content as the first image may be shown by refreshing the first image.

The wearable electronic device is a portable device which can be worn by a user in front of the eyes so that light incident on the left glass is transmitted to the eye in a transparent state of the glass and blocked to reach the eye in a dark state of the glass and similarly light incident on the right glass is transmitted to the right eye in a transparent state of the glass and blocked to reach the right eye in a dark state of the glass. In other words, the glasses can be switched between at least two states, a transparent state and a dark state which correspond to open and close the glass or another opening in a pair of glasses or some kind of goggles so that light reaching the glass or opening is transmitted or blocked, respectively.

For example, the wearable electronic device may be designed similarly to shutter glasses which are used to view three-dimensional content by alternately darkening one glass and letting light through the other glass so that at each instant in time light from a display only reaches either the left or the right eye.

In contrast to known shutter glasses, the wearable electronic device controls the state of the glasses such that at the same time the left and the right glass are both in a dark state. Switching into the dark state is preferably done periodically, e.g. every 20 milliseconds for ten milliseconds. Similarly, both glasses can be switched into a transparent state periodically, e.g. every 20 milliseconds for ten milliseconds, whereas the period for dark states may start at a time equal to zero and the period for transparent states at a time equal to 10 milliseconds. According to this example, the periods for dark states and transparent states would be shifted by 10 milliseconds.

Similarly, glasses intended for augmented reality can be adapted to be controlled in the way described above. Such augmented reality glasses also have the ability to shift between a dark and a more or less transparent state, since they comprise a matrix of pixels, wherein a pixel can be switched between a dark, i.e. non-transparent, state and a transparent state.

Accordingly, a left glass and/or a right glass may be constituted by a matrix of pixels that is adapted to change between a dark state and a more transparent state.

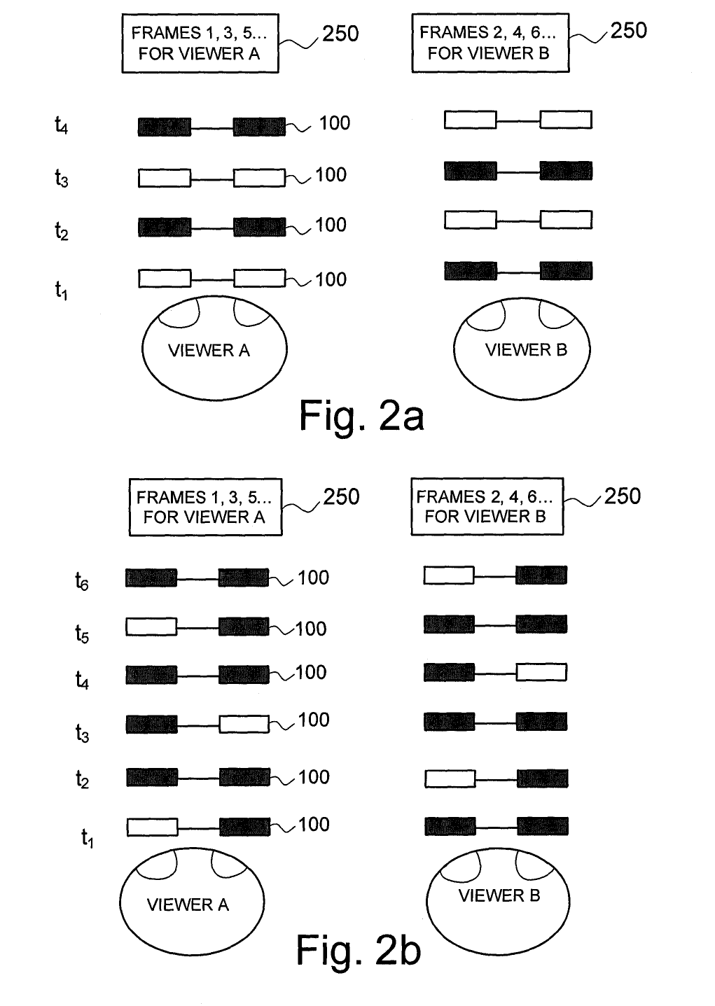

In the following, control of the operation of the wearable electronic device 100 with time is shown in FIG. 2a and FIG. 2b.

In FIG. 2a, a display device is indicated with reference numeral 250 and a viewer A and a viewer B are shown viewing the display device 250 at different times, at which the wearable electronic device 100 assumes different optical states.

In FIG. 2a, it is assumed that the display device displays different image frames, e.g. ten image frames, wherein the optical state of the wearable electronic device 100 of viewer A is controlled in such a way that the viewer A only views the odd-numbered frames, such as frames 1, 3, 5, 7 and 9. Therefore, at a time t₁ the electronic device 100 has its left and right glasses in a transparent state so that the left and the right eye of viewer A can view the image frame 1. At time t₂ both glasses are in a dark state so that image frame 2 cannot be seen by viewer A. Subsequently, at time t₃, both glasses are again switched in a transparent state so that the viewer A can view image frame 3. At time t₄ both glasses are again switched at the same time in a dark state.

Accordingly, the left glass and the right glass are periodically in a dark state at the same time, namely at times t₂ and t₄ corresponding to image frames 2 and 4, respectively, and also, which is not shown, at times t₆, t₈ and t₁₀ for the example describing ten image frames. Similarly, the left and the right glass are periodically in a transparent state at the same time, namely at times t₁ and t₃, as well as the not shown times t₅, t₇ and t₉.

In other words, as shown on the left side of FIG. 2a, the left glass and the right glass of electronic device 100 are both alternately in a transparent state at one time and in a dark state at another time.

On the other hand, which is also shown in FIG. 2a, a viewer B may wear a second electronic device, wherein the glasses of the second electronic device are controlled in such a way that the viewer B only sees the even-numbered image frames displayed by the display device 250. That is, at time t₁ the glasses of the electronic device are both in a dark state, at time t₂ the glasses are both in a transparent state and so on. As shown in FIG. 2a, the controller of the electronic device of viewer B controls the state of the glasses of the second pair of glasses so that the left glass and the right glass are both switched in the dark state at the same time when images of the first image series are displayed.

In detail, when comparing the state of the glasses of the electronic device of viewer A and the electronic device of viewer B, it is realized that the display device 250 may transmit two image series, namely a first image series with image frames 1, 3, 5, 7 and 9 and a second image series with image frames 2, 4, 6, 8 and 10. Accordingly, both viewers may watch two different programs corresponding to the different image series over the same time period, i.e. when sitting next to each other in front of the display device so that each viewer may view the program he/she likes most while not giving up the company of the other viewer, wherein the display device sequentially displays a plurality of images serving both viewers.

In case the two different image series correspond to different TV programs with different sounds, headphones may be provided to viewer A and viewer B so that the sound suitable to the program can be provided individually to each one of the viewers.

However, as will be shown below, one of the images series may be a website or other web content without sound so that headphones may not be necessary.

Furthermore, if only one viewer, such as viewer A is provided with the electronic device 100 and wants to view private content, for example in public space, the image series, such as image frames 2, 4, 6, 8 and 10, blocked by the electronic device 100 of viewer A may show inverted images to the first image series so that other people in the vicinity of the display device 250 not having an electronic device with the same synchronization as the one of viewer A will see a gray image. In other words, in a privacy mode, the purpose is to create images that differ from the images for viewer A, namely being inverted to the images of viewer A so that an overall, for example, 50%, grey image is perceived by a viewer without glasses.

Therefore, in one case, the second image series may constitute a second program for a second user, such as viewer B and in another case, the second image series may constitute inverted images to the first image series so as to enable a privacy mode for viewer A.

As shown above, the controller of the electronic device 100 in the example of FIG. 2a is adapted to control the state of the glasses so that the left glass and the right glass are both switched in a dark state when images of the second image series are displayed and both glasses are switched in a transparent state when images of the first image series are displayed.

In the following, in FIG. 2b, a similar operation as in FIG. 2a is described, however, each viewer is provided with two different perspectives so as to achieve three-dimensional perception.

Similarly to FIG. 2a, the viewer A of FIG. 2b is provided with the electronic device 100, the glasses of which are controlled to be in the dark state at times t₂, t₄, t₆, t₈ and t₁₀, as shown in FIG. 2b. However, in contrast to FIG. 2a, the glasses at times t₁, t₃, t₅, t₇ and t₉ are not both switched in a transparent state but only one of the glasses one at a time. In other words, as shown in the example, at time t₁, the left glass is in the transparent state and the right glass in the dark state and at t₃, the left glasses is in the dark state and the right glass in the transparent state.

Therefore, at time t1, the viewer A views the image frame 1 with the left eye and at time t₃ the viewer A views the image frame 3 with the right eye. Accordingly, different perspectives can be transmitted to different eyes, i.e. image frame 1 can be a perspective for the left eye and image frame 3 a perspective for the right eye and similarly, image frame 5 a perspective again for the left eye so that a three-dimensional perception by the viewer viewing the display device 250 can be achieved.

In parallel thereto, a viewer B, as seen on the right side in FIG. 2b, can also be provided with three-dimensional information, whereas at time t₁ both glasses of the electronic device of viewer B are in the dark state so that the viewer B does not see image frame 1.

As can be seen in FIG. 2b, the electronic device of viewer B is controlled in such a way that the odd-numbered frames are blocked for a viewer B and the even-numbered frames are received by viewer B, namely alternately by the left eye and the right eye.

It should be clear that the control operation shown in FIG. 2b is only an example, and other control operations exist that lead to a similar effect, such as providing an image to the left eye at t₁ and to the right eye at t₂ of viewer A and blocking the light at t₁ and t₂ for viewer B and subsequently blocking the light at t₃ and t₄ for viewer A and providing an image for the left eye at t₃ and for the right eye at t₄ for viewer B.

Accordingly, with respect to the case of viewer A, the first image series comprises images with different perspectives for each eye of the user, which are alternately displayed, and the controller of the electronic device is adapted to control the state of the glasses alternately so that said left glass is transparent for one perspective and the right glass is transparent for the other perspective. As a result, it should be avoided that the perceived image of the viewer gets darker since fewer light reaches the eyes of the viewer, by increasing the intensity, and a high frame rate should be provided so that the viewer sees smooth movements in the images.

It should also be understood that this scheme is not limited to two viewers but as long as the frequency of the display device 250, namely the number of newly displayable frames per second, is high enough, more than two viewers can be provided with image series. For example, a viewer should be provided with approximately 50 image frames a second to perceive a smooth non-flickering program. Frame rates above 100 Hz are already easily achievable today and in the future, display devices with frame rates of up to 200 Hz should be common.

As described above, the example shown in FIG. 2a providing two image series to two different users has been extended to provide three-dimensional image information of two different programs to two different users in FIG. 2b. However, three-dimensional information can also be obtained with the control operation of FIG. 2a if the display device is an auto-stereoscopic display device. In such display devices, different pixels are provided for different eyes.

For example, the odd-numbered columns of pixels of the display are provided for the left eye and the even-numbered columns of the display are provided for the right eye. This is achieved by using optical elements, such as lenses or prisms provided in front of the pixels. Accordingly, viewer A of FIG. 2a may be provided with two different perspectives at the same time, e.g. time t₁, time t₃, etc., even so both glasses are in the transparent state, since the two perspectives are transmitted from the display device in different directions in space. Therefore, the position of viewer A is important to perceive good three-dimensional information.

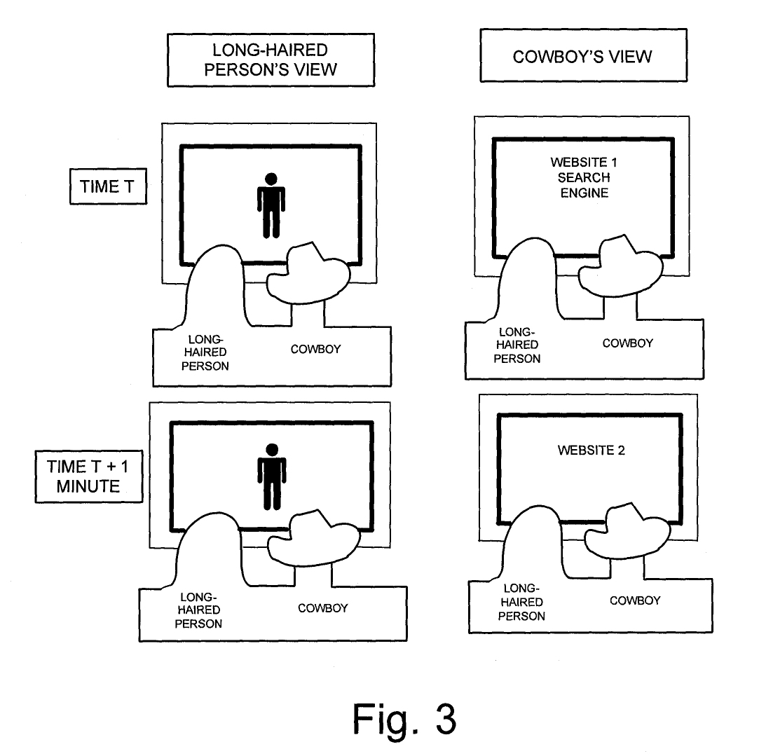

In the following in FIG. 3, an example how different content can be delivered to different users viewing the same display device is shown. In detail, two viewers, the long-haired person and the cowboy watch TV and surf the Internet, respectively. Both viewers wear an electronic device, such as the wearable electronic device 100 described above.

Therefore, the viewers can be provided with two-dimensional or three-dimensional information as described with respect to FIGS. 2a and 2b. For example, the long-haired person watches TV and the cowboy zaps around to check out what is on or uses the internet while the long-haired person continues to watch TV. Accordingly, both viewers can watch two different programs next to each other.

Similarly, the two viewers can also watch the same program but from different camera angles, if available, wherein in this example also no problem with different sounds occurs. Furthermore, if the viewers are playing a game using the same display device, each user may have a different view, for example the view of the gaming figure the user is associated to.

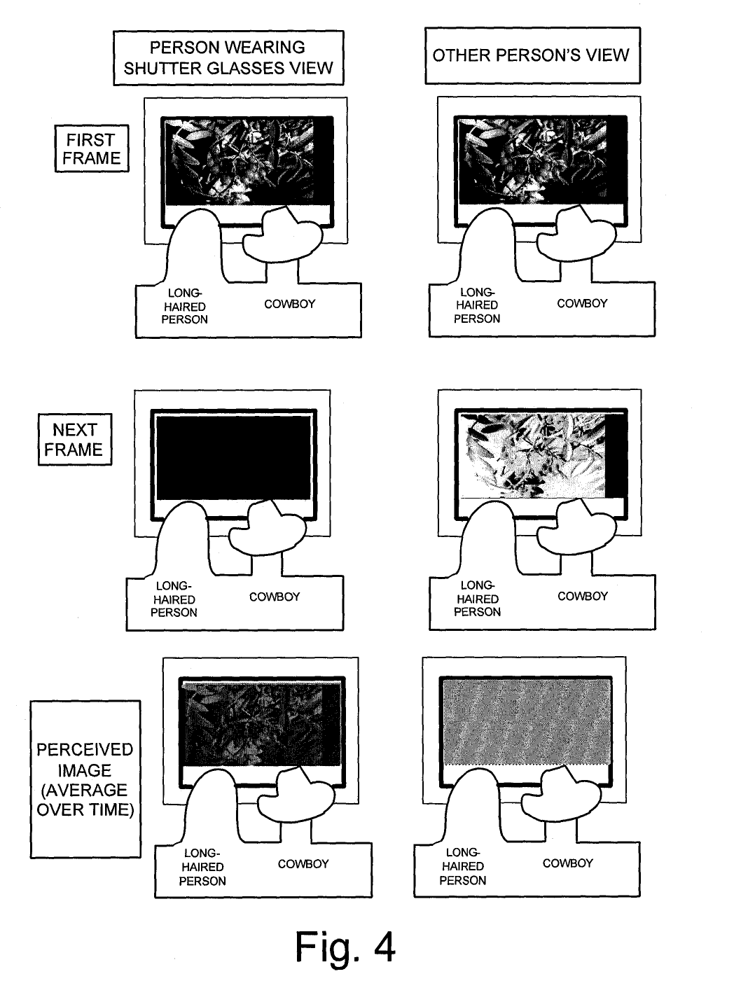

In the example of FIG. 4, it is shown how a user may view private content on a display device although other people see the display device at the same time.

In this example, two viewers, a long-haired person and a cowboy watch a display, wherein only one of them, e.g. the long-haired person, wears an electronic device, such as the electronic device 100. The long-haired person wearing the electronic device does not want to share the content being watched with the other person. In this case inverted images are displayed between normal images.

For example, every second image is an inverted image of the previously shown image. The controller of the electronic device 100 controls the glasses such that both glasses are in the dark state when the inverted image is shown. Therefore, the long-haired person wearing the electronic device 100 can watch a program while the cowboy not wearing an electronic device, such specially adapted shutter glasses or glasses for augmented reality, only sees a gray image.

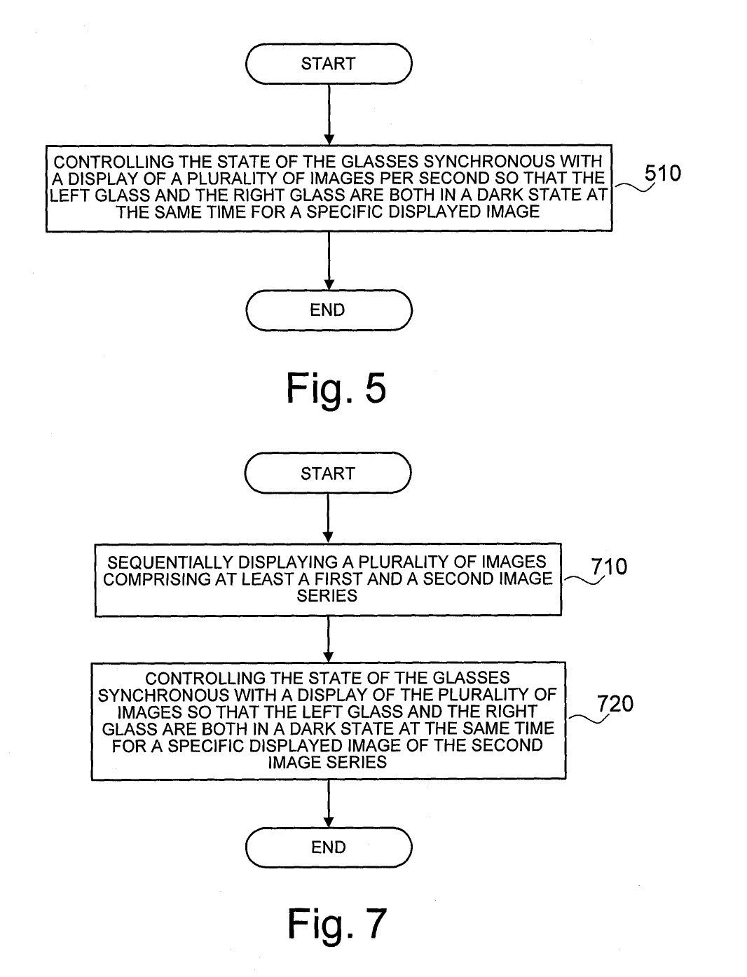

In the following, operations of a method for operating an electronic device, such as the wearable electronic device 100, will be described with respect to FIG. 5.

The wearable electronic device has a left glass and a right glass for watching images, as described above, and the left glass and the right glass are adapted to change between a dark state and a transparent state. In step 510 the state of the glasses is controlled synchronous with a display of a plurality of images per second so that the left glass and the right glass are both in a dark state at the same time for a specific displayed image. Details of the control have been described above and it is referred to these sections to avoid unnecessary repetition.

For example, as described above, the control is carried out by a controller, such as some kind of control unit or a control chip, in the electronic device to control and drive the change in the glasses. For example, a signal is received at the electronic device and is processed by the controller which controls a change in the state of the glasses. Details of signalling and controlling are described in the following.

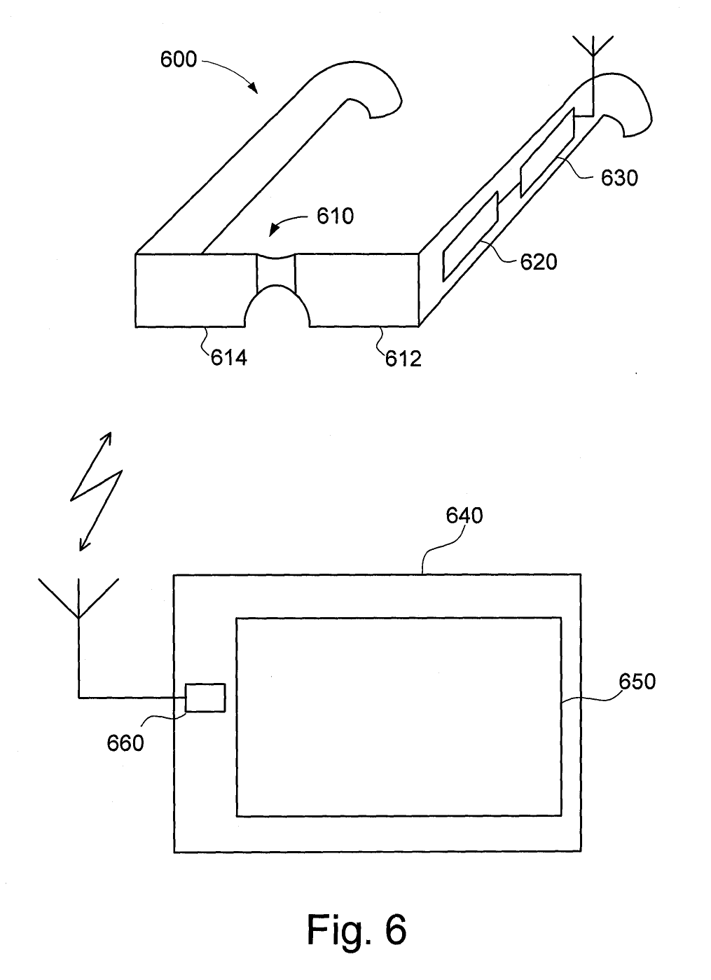

FIG. 6 illustrates a viewing system and elements thereof according to another embodiment of the invention. The viewing system comprises a wearable electronic device, such as the electronic device 100 or in this example the electronic device 600.

The electronic device 600 comprises a pair of glasses 610 having a first glass 612 and a second glass 614 and a controller 620, similar to the wearable electronic device 100 of FIG. 1. In addition to these elements, the electronic device 600 comprises a receiving section 630 operable to receive a signal indicating to the controller 620 to control the state of the glasses 612, 614 so that the left glass and the right glass are both switched to a dark state at the same time.

The signal to be received by the receiving section 630 may be sent from a display device, in particular a transmitting section of the display device.

An example of such a display device also forming part of the viewing system is also resented in FIG. 6. The display device 640 of FIG. 6 comprises a display section 650 and a transmitting section 660.

In detail, the display section 650 is operable to sequentially display a plurality of images, wherein the plurality of images includes at least a first and a second image series. Therefore, the display device 640 is comparable to the previously described display device 250 and comprises similar functions which have been described above.

Additionally, the display device 640 comprises a transmitting section 660 operable to transmit a signal indicating the display of images of the first image series and of the second image series so as to switch a state of both glasses of a pair of glasses at the same time in a dark state synchronous with the display of the second image series.

Transmitting the signal may be performed via a wired connection or wirelessly, e.g. by radio communication, such as WLAN or Bluetooth or other known radio links, as indicated in the figure.

In detail, the signal transmitted by the transmitting section 660 is basically used as a trigger to trigger in the wearable electronic device 600 a change in the optical state of the glasses so that a user of the electronic device 600 is presented with the image series selected by him/her. An image series may constitute a TV program, a movie, a website or images with subtitles. Accordingly, a second image series for a second user may also constitute a TV program, a movie, a website, etc. For example, two viewers may be provided with the same movie but with different subtitles so that the first user watches the movie with Chinese subtitles and the second user watches the same movie with Spanish subtitles. Accordingly, the different electronic devices of the two different users may also receive two different signals from the transmitting section 660, which may be a simple transmitter for the above-described radio communication schemes.

For example, the signal transmitted by the display device 640 and received by the electronic device 600 causes the controller 620 to control the glasses of the electronic device 100 of viewer A according to the examples shown in FIG. 2a, and similarly a different signal or also the same signal having two information embedded, may trigger the electronic device of viewer B of FIG. 2a to control the glasses as shown in FIG. 2a. Additionally, the signal may also cause the controller of the electronic device to control the glasses in accordance to the scheme of FIG. 2b.

The images to be displayed are sent to the display in sync with sending signals to the wearable electronic devices controlling which eye can see the actual image in the way a stereoscopic view can be obtained. The images can be sent at double the frequency of the wanted frame rate. There is no limitation to which display technology is used as long as it is fast enough for the required frame rate.

For example, the display device 640 may also comprise a controller (not shown) which controls the display of the images and generating and transmitting of a signal to trigger the corresponding control of the electronic device or devices.

In the following, a method for operating a viewing system, such as the viewing system of FIG. 6 is described with respect to FIG. 7.

FIG. 7 illustrates a flow diagram of the operations of a method for operating a viewing system with a display device and an electronic device having a left glass and a right glass, wherein the left glass and the right glass are adapted to change between a dark state and a transparent state of the glass.

In a first step 710, a plurality of images is sequentially displayed per second, wherein the plurality of images comprises at least a first and a second image series. As described above, the image series may be one of or a combination of, TV programs, movies, websites and movies with subtitles or other images.

According to the displayed image of the first or second image series, the state of the glasses is controlled synchronous with the display of the plurality of images so that the left glass and the right glass are both in a dark state at the same time for a specific displayed image of the second image series, as shown in step 720.

Details of this operation have been shown and described previously with respect to FIGS. 2a, 2b, 3, 4 and 6.

The description above has mentioned several individual elements, such as controllers, a receiving section, a transmitting section, a transmitting section, etc., and it should be understood that the invention is not limited to these elements as structural units, but these elements should be understood as elements comprising different functions. In other words, it is understood by the skilled person that an element in the above-described embodiments is not construed as being limited to a separate tangible part, but is understood as a kind of functional entity so that several functions may also be provided in one tangible part.

Moreover, the physical entities according to the invention and/or its embodiments, in particular the controller 120, 620 or the controller of the display device, may comprise or store computer programs including instructions such that, when the computer programs are executed on the physical entity, steps, procedures and functions are carried out according to the embodiments of the invention, e.g. according to the above-described methods. The invention also relates to computer programs for carrying out the function of the elements, and to a computer-readable medium storing computer programs for carrying out methods according to the invention.

The above-described elements of the wearable electronic device, the display device or the viewing system may be implemented in hardware, software, field-programmable gate arrays (FPGAs), application specific integrated circuits (ASICs), firmware or the like. It should be appreciated that various modifications and variations can be made in the described elements, wearable electronic devices, display devices and viewing systems and methods as well as in the construction of this invention without departing from the scope or spirit of the invention. The invention has been described in relation to particular embodiments which are intended in all aspects to be illustrative rather than restrictive. Those skilled in the art will appreciate that many combinations of hardware, software and firmware are suitable for practicing the invention.

Moreover, other implementations of the invention will be apparent to the skilled person from consideration of the specification and practice of the invention disclosed herein. It is intended that the specification and the examples are considered as exemplary only. To this end, it is to be understood that inventive aspects may lie in less than all features of a single foregoing disclosed implementation or configuration. Thus, the true scope and spirit of the invention is indicated by the following claims.

1. Wearable electronic device for watching images, comprising
a left glass and a right glass which are adapted to change between a dark state and a transparent state of the glass; and
a controller operable to control the state of the glasses synchronous with a display of a plurality of images per second by a display device so that said left glass and said right glass are both in a dark state at the same time for a specific displayed image.

2. Wearable electronic device of claim 1, wherein said left glass and said right glass are periodically in a dark state at the same time.

3. Wearable electronic device of claim 1, wherein said left glass and said right glass are periodically in a transparent state at the same time.

4. Wearable electronic device of claim 1, wherein said left glass and said right glass are both alternately in a transparent state at one time and in a dark state at another time.

5. Wearable electronic device of claim 1, further comprising
a receiving section operable to receive a signal indicating to said controller to control the state of the glasses so that said left glass and said right glass are both switched in a dark state at the same time.

6. Viewing system, comprising the wearable electronic device of claim 1, and
a display device operable to sequentially display the plurality of images.

7. Viewing system of claim 6, wherein the plurality of images comprises at least a first and a second image series.

8. Viewing system of claim 7, wherein said controller is adapted to control the state of the glasses so that said left glass and said right glass are both switched in a dark state when images of the second image series are displayed.

9. Viewing system of claim 7, wherein the second image series constitutes a second program for a second user or inverted images to the first image series.

10. Viewing system of claim 7, wherein the first image series comprises images with different perspectives for each eye of a user which are alternately displayed, and said controller is adapted to control the state of the glasses alternately so that said left glass is transparent for one perspective and said right glass is transparent for the other perspective.

11. Viewing system of claim 6, further comprising
a second pair of glasses having a left glass and a right glass which are adapted to change between a dark state and a transparent state of the glass.

12. Viewing system of claim 11, wherein said controller is adapted to control the state of the glasses of said second pair of glasses so that said left glass and said right glass are both switched in a dark state at the same time when images of the first image series are displayed.

13. Viewing system of claim 6, wherein the display device comprises an auto-stereoscopic display device.

14. Display device for displaying images, comprising
a display section operable to sequentially display a plurality of images, wherein the plurality of images comprises at least a first and a second image series, and
a transmitting section operable to transmit a signal indicating the display of images of the first image series and of the second image series so as to switch a state of both glasses of a pair of glasses at the same time in a dark state synchronous with the display of the second image series.

15. Method for operating a wearable electronic device having a left glass and a right glass for watching images, the left glass and the right glass are adapted to change between a dark state and a transparent state of the glass, the method comprising the step
controlling the state of the glasses synchronous with a display of a plurality of images per second so that said left glass and said right glass are both in a dark state at the same time for a specific displayed image.

16. Method for operating a viewing system with a display device and an electronic device having a left glass and a right glass, the left glass and the right glass are adapted to change between a dark state and a transparent state of the glass, the method comprising the steps
sequentially displaying a plurality of images per second comprising at least a first and a second image series, and
controlling the state of the glasses synchronous with a display of the plurality of images so that said left glass and said right glass are both in a dark state at the same time for a specific displayed image of said second image series.
